(19) United States
(12) Patent Application Publication
(10) Pub. No.: US 2009/0193983 A1
(43) Pub. Date: Aug. 6, 2009

(54) FOOD CUTTING DEVICE

(76) Inventor: Kwok Kuen So, Hong Kong (CN)

Correspondence Address: LEYDIG VOIT & MAYER, LTD, 700 THIRTEENTH ST. NW, SUITE 300, WASHINGTON, DC, 20005-3960, US

(21) Appl. No.: 12/026,708

(22) Filed: Feb. 6, 2008

(51) Int. Cl. A23N 15/00; B26D 1/03; B26D 1/00

(52) U.S. Cl. 99/537; 83/857; 83/859

(57) ABSTRACT

A food cutting device has a frame defining an aperture within the frame and cutting blades located within the frame and extending across the aperture. The cutting blades are arranged in a lattice structure and have cutting edges facing in a common cutting direction. At least some of the cutting blades intersect with one another intersecting positions and include portions between at least some of the intersecting positions having reduced blade material, reducing contact area of the cutting blades with food when the food is being cut.

The present invention relates to a food cutting device and in particular, but not exclusively, a device for cutting food such as onion or cheese into dices.

### BACKGROUND OF INVENTION

Food cutting devices of the types concerned typically includes a lattice cutting blade arrangement which any, in a common form, comprise two sets of parallel cutting blades which intercept with each other at right angles to form a crisscross pattern. In operation, the cutter device is pressed upon the food to be cut, or alternatively the food pressed upon the cutter assembly, such that the food is cut by the blades into smaller pieces that pass through apertures between the blades.

Because a relatively large number of cutting blades are employed (typically ten to twenty), the force required to press the cutter device or the food can be large. This often means that the cutter device is hard to use, or results in the food getting squashed.

The invention seeks to obviate or at least alleviate such a problem or shortcoming by providing a new or otherwise improved food cutting device.

### SUMMARY OF THE INVENTION

According to the invention, there is provided a food cutting device for cutting food, comprising a frame defining an aperture therein and a plurality of cutting blades located within the frame across the aperture. The cutting blades are arranged in a lattice structure and having cutting edges facing in a common cutting direction. At least some of the cutting blades intercept with one another at certain intercepting positions and include portions between at least some of the intercepting positions having reduced blade-making material so as to reduce area of contact of such cutting blades with food when the latter is being cut.

Preferably, the portions of the cutting blades have reduced blade-making material behind their cutting edges.

Preferably, the portions of the cutting blades have reduced blade-making material in a rearward direction opposite the cutting direction.

More preferably, the portions of the cutting blades have a recessed edge profile facing in the rearward direction.

Further more preferably, the edge profile is smoothly concave.

Yet further more preferably, the edge profile is arcuate.

In a preferred embodiment, the cutting blades are located with their cutting edges at different positions in the cutting direction relative to the frame.

More preferably, some of the cutting blades are located with their cutting edges lying on substantially the same imaginary plane at right angles to the cutting direction, and some of the other cutting blades are located with their cutting edges lying out of that imaginary plane.

Further more preferably, some of the other cutting blades are located with their cutting edges substantially lying on a common imaginary plane at right angles to the cutting direction, the two imaginary planes being at different positions in the cutting direction relative to the frame.

It is preferred that the cutting blades are located with about half of their cutting edges substantially lying on a first common imaginary plane at right angles to the cutting direction and with the remainder substantially lying on a second common imaginary plane parallel to the first imaginary plane.

In a preferred embodiment, the food cutting device is a food dicer, in which the cutting blades are arranged as a crisscross lattice structure comprising two mutually perpendicular sets of cutting blades which intercept with each other.

### BRIEF DESCRIPTION OF DRAWINGS

The invention will now be more particularly described, by way of example only, with reference to the accompanying drawings, in which:

FIG. 1 is a perspective view of an embodiment of a food cutting device in accordance with the invention;

FIG. 2 is a top plan view of the food cutting device of FIG. 1;

FIG. 3 is a cross-sectional side view of the food cutting device of FIG. 2, taken along line III-III;

FIG. 4 is a cross-sectional side view of the food cutting device of FIG. 2, taken along line IV-IV;

FIG. 5 is a perspective view of a vertical chopper in which the food cutting device of FIG. 1 is in use; and

FIG. 6 is a perspective view of the vertical chopper and food cutting device of FIG. 5, showing the latter cutting food.

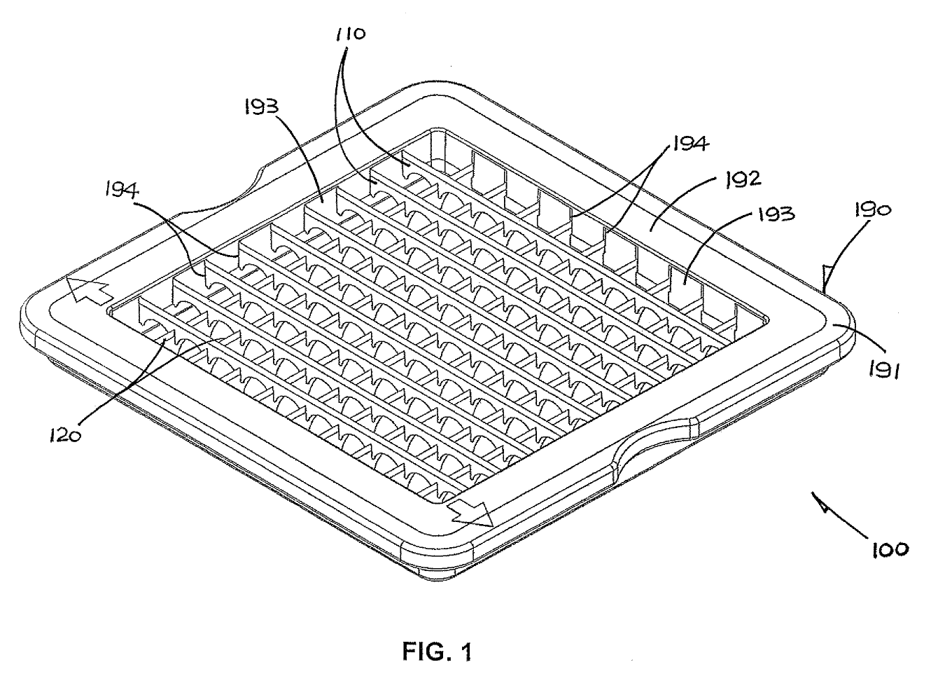

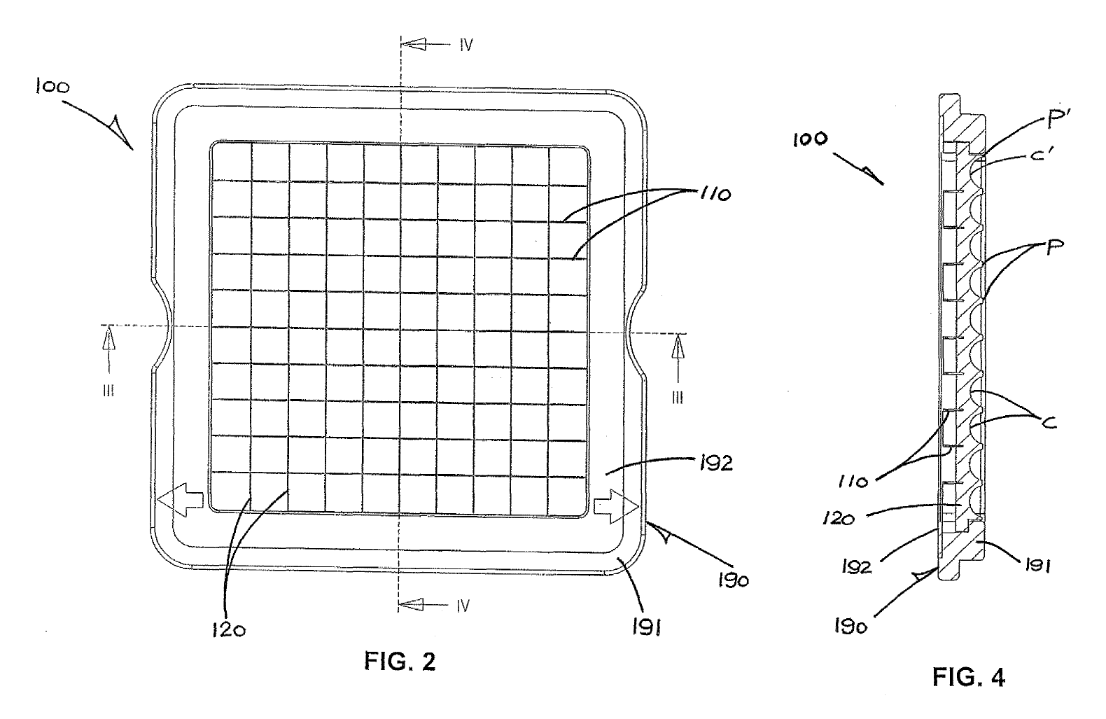

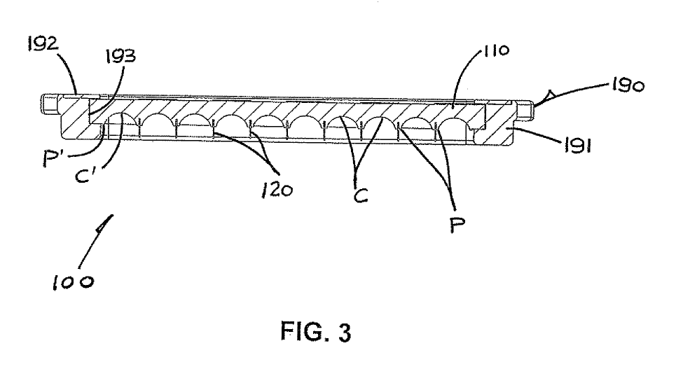

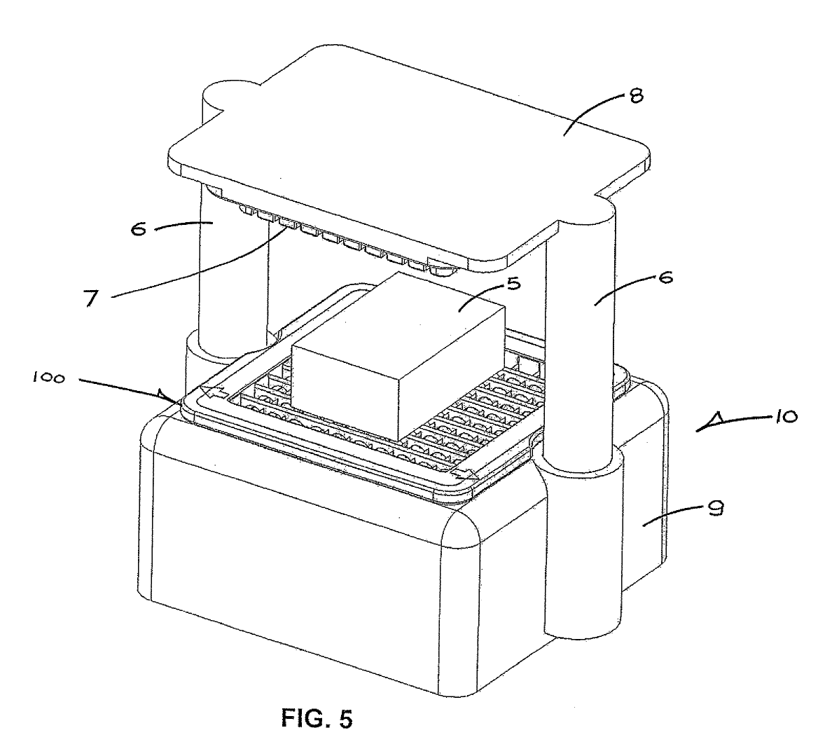

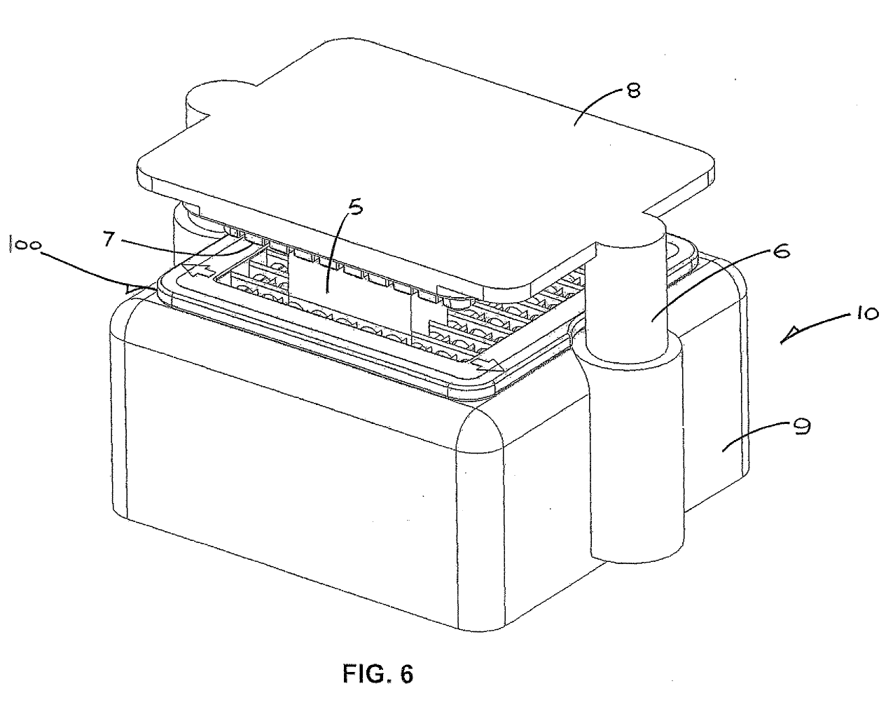

### DETAILED DESCRIPTION OF PREFERRED EMBODIMENT

Referring to the drawings, there is shown a food cutting device embodying the invention, which is in the form of a dicer blade insert 100 for use in a vertical chopper 10 for cutting food, such as onion, potato or cheese for example, into small pieces. The blade insert 100 is generally square planar, having a pair of left and right recesses.

The chopper 10 has a square hollow base 9 on which the blade insert 100 is to be placed, and includes an upper rectangular presser plate 8 bearing appropriate press formations 7. The presser plate 8 is slidable downwardly on a pair of opposite side posts 6 to press upon food 5 resting on the blade insert 100, whereby the food 5 is cut by and through the blade insert 100 into dices collected in the base 9. The blade insert 100 is located by its left and right recesses engaging the posts 6, and may be replaced by another blade insert of similar construction and size but a different cutting pattern.

The dicer blade insert 100 is formed by a square plastic frame 190 defining a square aperture therein and two sets each of nine co-parallel straight stainless steel cutting blades 110/120 that are located within, and surrounded by, the frame 190 across the aperture.

The frame 190 has a main frame body 191 having an open upper side, and a frame cover 192 covering that open upper side. The main frame body 191 includes four inner side peripheral walls 193 that are formed with evenly spaced slots 194, nine on each side, at right angles to the plane of the frame 190.

The cutting blades 110/120 of each set extend in a co-parallel and co-planar manner, having respective cutting edges facing in a common cutting direction. The first set of cutting blades 110 intercepts at right angles with the second set of cutting blades 120, together forming a crisscross lattice structure or cutting pattern.

Opposite ends of each cutting blade 110/120 are located in the relevant slots 194 of the main frame body 191 on opposite sides, with the frame cover 192 closed and fixed to secure the cutting blades 110/120 in place, such that the cutting blades 110 and 120 are fixed with the frame 190.

At each intercepting position, or junction, where two cutting blades 110 and 120 intercept, the blade 120 has a short slot at its cutting edge and the other blade 110 has a similar slot but at the rear edge opposite its own cutting edge. Both slots extend at right angles to the length of the blades 110 and 120, i.e. parallel to the cutting direction. The two blades 110 and 120 at each junction inter-engage by their slots, with each slot receiving or embracing the part of the other blade right behind its own slot, whereby the blades 110 and 120 interlock with each other.

The two blades 110 and 120 overlap with, or fit into, each other along the cutting direction but only to a limited extent. Their cutting edges are situated at different positions in the cutting direction relative to the frame 190.

More specifically, the two cutting blades 110 and 120 fit into each other only to a limited extent by reason of the lengths of their slots at the junction not adding up to the width of the blades 110 and 120 (as between cutting edge and rear edge). The extent to which the blades 110 and 129 overlap is small, for a distance no greater than a quarter of the blades' width (as is depicted in the drawings), but sufficient to hold the blades 110 and 120 firm against dislodgement from each other during use. With an overlapping distance up to one-fourth of the blades' width, the slots are (on average) at most only as long as one-eighth of the blades' width.

The use of such short slots brings about an advantage in that the rigidity of the blades 110 and 120 is not too much compromised, compared with the typical construction where the slots are as long as about half of the blades' width such that the cutting blades overlap over their entire width. Less material may now be used for making the cutting blades 110 and 120, and this in particular results in a reduction in the width of the cutting blades 110 and 120 (i.e. permitting the use of narrower cutting blades). Overall, the two sets of blades 110 and 120 interlock and fit together in the same manner.

The construction results in an offset arrangement in the cutting direction between the cutting edges of the two sets of blades 110 and 120, with the cutting edges of each set lying in substantially the same or a common imaginary cutting plane at right angles to the cutting direction. The two imaginary planes extend co-parallel, at different positions in the cutting direction relative to the frame 190.

In particular, the cutting edges of the first set of blades 110 are located ahead, or in front of, those of the other set of blades 120 in the cutting direction, such that the front set of blades 110 will cut into food before the second set of blades 120 does.

With a reduced number of cutting edges initially cutting or piercing into food (i.e. by half in the described embodiment), cutting can more easily and readily be started, without requiring too much force from the user and/or squashing or otherwise damaging the food.

As between the adjacent junctions of each pair, the portion of the related cutting blade 110/120 is made to have a smoothly concave, arcuate concave edge profile, in the form of a cutout R, along the rear edge of the blade 110/120. An identical recessed cutout C′ is formed in the portion of each blade 110/120 between an outermost junction and the adjacent inner side wall 193 of the frame 190. All the cutouts C and C′ face in a rearward direction opposite the cutting direction, each at a position behind the associated cutting edge.

Each of these cutouts C and C′ occupies almost the entire gap between the two adjacent junctions concerned, except over a very short distance (about 1 mm) across the left to right sides of each junction, i.e. a small part P in the drawings, where strength should be retained to compensate for the presence of the slot thereat interlocking with the other cutting blade 120/110. The part P is situated at where the relevant cutting blade 110/120 is widest, or the width uncompromised. The equivalent parts immediately adjacent the inner side walls 193 of the frame 190 are designated by the reference letter P′.

Each cutout C/C′ represents a reduction in the stainless steel material making the relevant cutting blade 110/120, and hence a reduction in the outer surface area of the blade 110/120 that may come into contact with the food as the food is being cut by that and neighboring blades 110 and 120.

By reducing the area of contact with the food, the cutting blades 110 and 120 would be subject to a (proportionally) smaller frictional or adhesive force by the food. The blades 110 and 120 can therefore cut through the food more easily, requiring a relatively smaller force from the person using the food chopper 10 or dicer blade insert 100.

The reduction in the area of the cutting blades 110 and 120 that may be contacted by food is achieved by firstly forming the cutouts C and C′ in or at the back of the blades 110 and 120 to reduce the blade-making material, and secondly by using shorter slots to interlock the two blades 110 and 120 as described above.

In the first solution, the cutouts C and C′ are made preferably in an arcuate shape (such as semi-circular) because an arcuate shape is effective in providing an adequate mechanical strength using a minimum quantity of the blade-making material. Having said that, it is envisaged that any other shapes can be adopted for such cutouts, or even a hole (of any shape) within the outline of the cutting blades.

In the second solution, the use of shorter interlocking slots between two sets of cutting blades 110 and 120 additionally brings about their cutting edges as between the two sets lying on respective offset cutting planes, thereby facilitating initial piercing of the front cutting edges into the food. It is envisaged that the initial piercing into food will be made easier so long as not all the cutting edges lie in substantially the same cutting plane i.e. cutting initially at the same time. Thus, for example, some of the cutting blades may be located with their cutting edges lying out of a common cutting plane shared by the cutting edges of certain other cutting blades.

In a nutshell, the dicer blade insert 100 as described above has a wavy or non-linear bottom edge along each of its cutting blades, and the two sets of mutually perpendicularly extending cutting edges 110 and 120 are offset in the cutting direction. The reason for adopting such wavy bottom edges is to minimize the side contact area with food. The reason for the aforesaid offset cutting edge arrangement is to reduce the area of initial piercing into food at the same time, such that the cutting pressure can be concentrated over only part of the cutting blades at the outset of cutting.

By using this structure, compared with traditional food cutting devices, considerably less force is required to cut food. The advantage is especially important for food dicers, as they have considerably more cutting blades to contact with food and hence are harder to cut than any other cutting devices.

In a different embodiment, the cutting blades may be arranged in a lattice structure other than a crisscross pattern of square open spaces as described herein. An example is a number of concentrically arranged circular cutting blades crossed by certain other cutting blades that are straight and extend radially.

In general, it is to be noted that the subject invention not only can be utilized in vertical choppers as described above, but can also be used in any other types of food cutters, slicers or chippers, etc. for cutting food of any kind. An example is potato, for which the cutter may incorporate cutting blades arranged in a checker pattern for cutting out strips to make French fries. A series of parallel linear cutting blades is suitable for cutting onion into rings.

The invention has been given by way of example only, and various other modifications of and/or alterations to the described embodiment may be made by persons skilled in the art without departing from the scope of the invention as specified in the appended claims.

1. A food cutting device for cutting food, comprising:
a frame defining an aperture within the frame; and
a plurality of cutting blades located within the frame and extending across the aperture, the cutting blades being arranged in a lattice structure and having cutting edges facing in a common cutting direction, wherein at least some of the cutting blades with one another at intersecting positions and include portions between at least some of the intersecting positions having reduced blade material, reducing contact area of the cutting blades with food being cut by the cutting blades.

2. The food cutting device as claimed in claim 1, wherein the portions of the cutting blades that have reduced blade material are located behind cutting edges of the cutting blades with respect to the cutting direction.

3. The food cutting device as claimed in claim 1, wherein the portions of the cutting blades have reduced blade material in a rearward direction, opposite the cutting direction.

4. The food cutting device as claimed in claim 3, wherein the portions of the cutting blades have a recessed edge profile facing in the rearward direction.

5. The food cutting device as claimed in claim 4, wherein the edge profile is smoothly concave.

6. The food cutting device as claimed in claim 5, wherein the edge profile is arcuate.

7. The food cutting device as claimed in claim 1, wherein the cutting edges of the cutting blades are located at different positions in the cutting direction, relative to the frame.

8. The food cutting device as claimed in claim 7, wherein some of the cutting edges of the cutting blades are located substantially on a first common imaginary plane that forms a right angle with the cutting direction, and the cutting edges of some of the cutting blades are not located on the first common imaginary plane.

9. The food cutting device as claimed in claim 8, wherein
the cutting edges of some of the cutting blades are located on a second common imaginary plane that forms a right angle with the cutting direction, and
the first and second common imaginary planes are located at different positions in the cutting direction, relative to the frame.

10. The food cutting device as claimed in claim 7, wherein about half of the cutting edges of the cutting blades lie substantially on a first common imaginary plane that forms a right angle with the cutting direction and about half of the cutting edges of the cutting blades lie substantially on a second common imaginary plane that is parallel to the first common imaginary plane.

11. The food cutting device as claimed in claim 1, being a food dicer, wherein the cutting blades are arranged as a crisscross lattice structure comprising two mutually perpendicular sets of cutting blades which intersect each other.
